(19) United States
(12) Patent Application Publication
(10) Pub. No.: US 2009/0240549 A1
(43) Pub. Date: Sep. 24, 2009

(54) RECOMMENDATION SYSTEM FOR A TASK BROKERAGE SYSTEM

(75) Inventors: Dean A. Slawson, Beijing (CN); Raman Chandrasekar, Seattle, WA (US)

Correspondence Address: PERKINS COIE LLP/MSFT, P. O. BOX 1247, SEATTLE, WA, 98111-1247, US

(73) Assignee: Microsoft Corporation, Redmond, WA (US)

(21) Appl. No.: 12/053,280

(22) Filed: Mar. 21, 2008

(51) Int. Cl. G06Q 10/00

(52) U.S. Cl. 705/9; 705/7; 705/11

(57) ABSTRACT

A recommendation system is provided that recommends tasks to be performed on electronic documents, providers for performing tasks on documents, and prices for tasks that are to be performed on the documents. In some embodiments, the recommendation system works in conjunction with a task brokerage system provided by a broker that helps customers who need tasks to be performed on documents to identify providers who can perform the requested tasks. The task brokerage system allows customers to publish their tasks and providers to discover the published tasks. The discovery process may match providers to customers based on criteria such as reputation, pricing, and availability.

### CROSS-REFERENCE TO RELATED APPLICATION(S)

This application is related to U.S. patent application Ser. No. 12/026,523, entitled “Affordances Supporting Microwork on Documents,” and Filed on Feb. 8, 2008 and U.S. patent application Ser. No. ______ (41826.8478US), entitled “Machine Learning for a Task Brokerage System,” and filed on Mar. 21, 2008, which are hereby incorporated by reference.

### BACKGROUND

Labor markets facilitate an efficient division of labor to perform various projects. Typically, a person who requires a project to be performed searches for and hires the services of qualified persons to perform the project. However, the granularity at which a project may be practically divided into tasks that can then be performed by different persons (or more generally entities) has been relatively coarse. For example, the building of a house can be divided into coarse tasks such as build the foundation, frame the house, install the roof, and so on. The division of a project into more fine-grained tasks has been limited by a variety of factors such as management overhead, skills availability, difficulty of efficiently matching buyers and sellers, issues surrounding confidentiality and trust, and so on. The limits may be especially problematic for knowledge workers (e.g., people who generate electronic documents such as scholarly articles, professional drawings, patent applications, and presentations). These knowledge workers who are typically highly specialized often need tasks to be performed that are outside their area of expertise. For example, a physics professor in China who is writing a scholarly article in English on the formation of black holes may not be particularly knowledgeable about English grammatical rules. To ensure that the article is free of grammatical errors, the professor needs a skilled editor to review the article. Similarly, the professor may not be familiar with drawing tools needed to make the figures of the article look professional. Unless the professor's university happens to have a skilled editor for the English language or a skilled draftsperson on staff in the physics department, it can be difficult for the professor to find the right persons to perform those tasks.

Some systems are available to help knowledge workers manage tasks. For example, a project management tool can help a manager in a company track a complex project such as generating a request for proposal or preparing a response to a request for proposal. If the knowledge workers to whom tasks are assigned are employees of the company, it can be fairly easy for the manager to assign the tasks of the project. It, however, becomes more difficult if the tasks need to be assigned to people outside the company. As another example, a workflow tool may allow a manager to specify the workflow sequence for a document. The workflow may specify that a certain junior writer is to generate the first draft, a certain senior writer is to revise and approve it, an editor is to review and edit it, a draftsperson is to generate professional drawings for it, a layout person is to format it, and so on. These tools, however, do not provide much assistance in helping a manager or knowledge worker identify who can perform a task (especially when the skill to perform the task is not readily available), how to describe the needed task, how much to pay for the task, what tasks are really needed, and so on.

### SUMMARY

A recommendation system is provided that recommends tasks to be performed on electronic documents, providers for performing tasks on documents, and prices for tasks that are to be performed on the documents. In some embodiments, the recommendation system works in conjunction with a task brokerage system provided by a broker that helps customers who need tasks to be performed on documents to identify providers who can perform the requested tasks. The task brokerage system allows customers to publish their tasks and providers to discover the published tasks. The discovery process may match providers to customers based on criteria such as reputation (of the customer and/or the provider), pricing, and availability.

In some embodiments, the recommendation system recommends a type of task to be performed on an electronic document based on whether characteristics of the documents satisfy recommendation criteria. The recommendation system provides recommendation criteria that specify a condition and a task. The recommendation system may allow recommendation criteria to be defined by brokers, providers, or even customers. The recommendation system may apply the recommendation criteria to a document when various events occur. If the condition of a recommendation criterion is satisfied, the recommendation system recommends the task of the recommendation criterion to a customer. After the recommendation system has recommended a task, the recommendation system can be used to recommend a price and/or a provider for the task as discussed below. The task brokerage system can then be used to coordinate having a provider perform the recommended task.

In some embodiments, the recommendation system recommends a price for a task that is to be performed by a provider on a document. The recommendation system may monitor transactions that are performed by the providers of tasks on documents of customers. The task brokerage system may have a facility that collects extensive information about each transaction. The recommendation system, upon receiving a description of a target task to be performed on a document, analyzes the transaction history to identify transactions with tasks that are similar to the target task. The recommendation system then calculates a price (e.g., expressed as a range of prices) for the target task based on the prices of the similar tasks.

In some embodiments, the recommendation system recommends to a customer a provider to perform a target task on a document of the customer. The recommendation system provides profiles of providers including, among other information, the types of tasks that the providers perform. The recommendation system may also monitor the performance of providers in performing tasks on documents for customers and store performance history information for the providers. The recommendation system may also collect from customers rating information on the providers. Upon receiving a description of a target task to be performed on a document, the recommendation system analyzes the provider profiles, the performance history information, and the rating information to identify providers who are qualified to perform the target task. The recommendation system may generate a score for each qualified provider indicating the expected overall satisfaction of the customer with the performance of the provider. The recommendation system may then rank the qualified providers based on their scores and present the providers to the customer.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram that illustrates components of the recommendation system in some embodiments.

FIG. 2 illustrates a provider profile table used by the recommendation system in some embodiments.

FIG. 3 illustrates a recommendation criteria store of the recommendation system in some embodiments.

FIG. 4 is a flow diagram that illustrates the processing of the recommend task component of the recommendation system in some embodiments.

FIG. 5 is a flow diagram that illustrates the processing of the evaluate condition component of the recommendation system in some embodiments.

FIG. 6 is a flow diagram that illustrates the processing of the recommend provider component of the recommendation system in some embodiments.

FIG. 7 is a flow diagram that illustrates the processing of the recommend price component of the recommendation system in some embodiments.

### DETAILED DESCRIPTION

A recommendation system is provided that recommends tasks to be performed on electronic documents, providers for performing tasks on documents, and prices for tasks that are to be performed on the documents. In some embodiments, the recommendation system works in conjunction with a task brokerage system provided by a broker that helps customers who need tasks to be performed on documents to identify providers who can perform the requested tasks. The task brokerage system allows customers to publish their tasks and providers to discover the published tasks. The discovery process may match providers to customers based on criteria such as reputation, pricing, and availability.

A recommendation system is provided that recommends tasks to be performed on electronic documents, prices for tasks that are to be performed on the documents, and providers for performing tasks on documents. In some embodiments, the recommendation system works in conjunction with a task brokerage system as described in U.S. patent application Ser. No. 12/026,523. A task brokerage system provided by a broker (also referred to as a “microwork broker”) that helps customers (also referred to as “microwork customers”) who need tasks (also referred to a “microtasks”) to be performed on documents to identify providers (also referred to as “microwork providers”) who can perform the requested tasks. The task brokerage system allows customers to publish their tasks and providers to discover the published tasks. The task brokerage system may also maintain reputations of the customers and providers who are “participants” in the brokering of tasks. The reputations may be derived from customer ratings of providers and provider ratings of customers. The discovery process may match providers to customers based on criteria such as reputation, pricing, and availability. The task brokerage system may provide facilities by which a customer can help ensure that a provider will preserve the confidentiality of the customer's information.

In some embodiments, the recommendation system recommends a type of task to be performed on an electronic document based on whether characteristics of the documents satisfy recommendation criteria. (As used herein, “task” refers to both the type of work that needs to be performed (e.g., editorial review) and a more general description of the specific work that is needed (e.g., type of work, document, price, and due date).) The recommendation system provides recommendation criteria that specify a condition and a task. A condition may be an expression derived from characteristics of the document that evaluates to a true or false value. For example, a recommendation criterion may have a condition specifying that the number of grammatical errors per page of the document is greater than three and a task of editorial review. The number of grammatical errors per page is a characteristic of a document that may be generated by the word processing program used to create the document or by a separate grammar checker. If the document averages more than three grammatical errors per page, then the condition of the recommendation criterion is satisfied and the recommendation system recommends to the customer who generated the document that an editorial review task be performed. The recommendation system may allow recommendation criteria to be defined by brokers, providers, or even customers. For example, a provider who can perform a certain task and believes that that task should be performed under certain conditions may submit a recommendation criterion to the task brokerage system. The task brokerage system may automatically add the recommendation criteria of providers who have demonstrated their trustworthiness at providing accurate recommendation criteria and may require manual intervention to review recommendation criteria of providers who have not demonstrated sufficient trustworthiness. The recommendation system may apply the recommendation criteria to a document when various events occur. For example, a customer may have installed at its computer system a module of the recommendation system that provides the customer with the option of asking for recommended tasks. Alternatively, the module can monitor the customer's activity (e.g., opening or closing a document and sending the document via electronic mail) and automatically recommend tasks. As another example, the recommendation system may recommend tasks when a user requests to publish the document. After the recommendation system has recommended a task, the recommendation system can be used to recommend a price or a range of prices and a provider for the task as discussed below. The task brokerage system can then be used to coordinate having a provider perform the recommended task.

In some embodiments, the recommendation system recommends a price for a task that is to be performed by a provider on a document. The recommendation system may monitor transactions that are performed by the providers of tasks on documents of customers. The task brokerage system may have a facility that collects extensive information about each transaction. For example, the collected information may include the customer's name, the provider's name, location of the customer and the provider, the task, the price, ratings of the customer and the provider, ratings of the transaction by the customer and the provider, and so on. The recommendation system, upon receiving a description of a target task to be performed on a document, analyzes the transaction history to identify transactions with tasks that are similar to the target task. Each task specifies what needs to be done (task type), when it needs to be done, desired provider profile, the document, maximum price, and so on. The recommendation system may use various techniques to assess the similarity of the tasks. For example, the recommendation system may represent features of the tasks as feature vectors and use the feature vectors to calculate a cosine-based similarity. As another example, the recommendation system may employ various clustering techniques to identify clusters of similar tasks. The recommendation system then calculates a price for the target task based on the prices of the similar tasks. For example, the price may be an average of the prices weighted by the similarity of the task to the target task, median of the prices, and so on. The recommendation system may also present to a participant graphic information illustrating the prices of the similar tasks. For example, one graph may show price versus provider rating, price versus turnaround time, other timing requirements, and so on. A recommended price or range of prices can be provided to a customer who wants to publish a task or a provider who wants to perform a task.

In some embodiments, the recommendation system recommends to a customer one or more providers to perform a task on a document of the customer. The recommendation system provides profiles of providers including, among other information, the types of tasks that the providers perform (e.g., editorial review, translation from English to French). The recommendation system may also monitor the performance of providers in performing tasks on documents for customers and store performance history information for the providers. For example, the performance history information may include timeliness of the performance of tasks, quality of the performance, and so on. The recommendation system may also collect customer ratings of the providers. Upon receiving a description of a target task to be performed on a document, the recommendation system analyzes the provider profiles, the performance history information, and the rating information to identify providers who are qualified to perform the target task. A provider is qualified to perform a target task when the provider provides the appropriate type of task and satisfies other criteria of the task such as minimum rating of the provider as required by the task. The recommendation system may generate a score for each qualified provider indicating the expected overall satisfaction of the customer with the performance of the provider. For example, the recommendation system may compare characteristics of the providers with characteristics of other providers for whom the customer expressed satisfaction. The recommendation system may then rank the qualified providers based on their scores and present the providers to the customer.

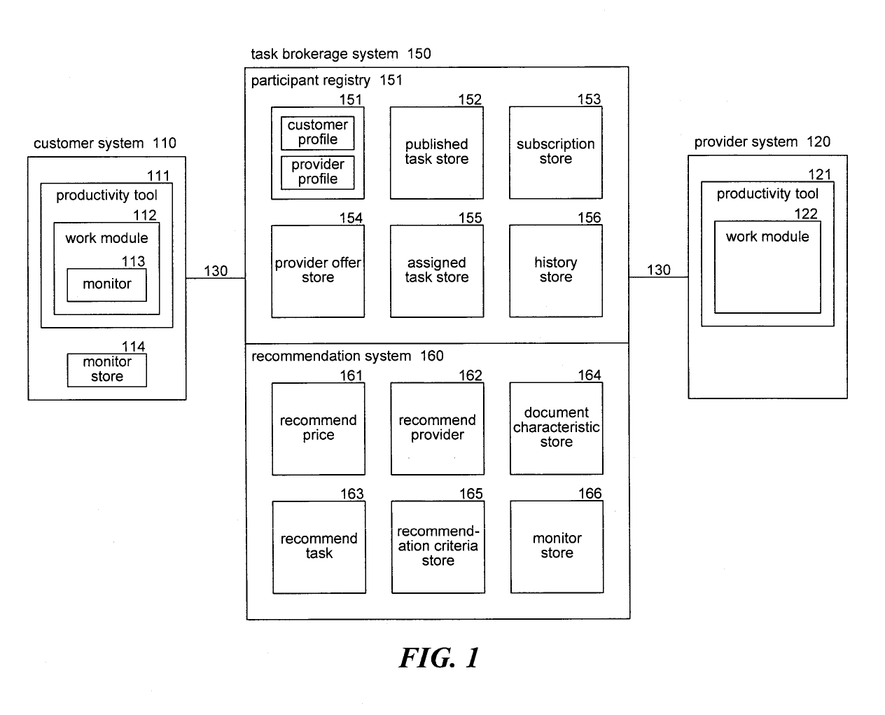

FIG. 1 is a block diagram that illustrates components of the recommendation system in some embodiments. The task brokerage system 150 may be connected to customer systems 110 and provider systems 120 via communication links 130. A customer system may include a productivity tool 111 (e.g., a word processing program and a drawing program) with an add-in work module 112 that provides customer-side functionality of the task brokerage system, which may assist a customer in publishing a task. The work module may also include a monitor component 113 that monitors the activity of the customer and stores information describing the activity in the monitor store 114. The provider system may also include a productivity tool 121 with an add-in work module 122 that provides provider-side functionality of the task brokerage system, which may assist a provider in discovering and evaluating tasks and evaluating customers. The task brokerage system 150 may include a participant registry 151, a published task store 152, a subscription store 153, a provider offer store 154, an assigned task store 155, and a history store 156. The participant registry may contain customer and provider profile information. The published task store contains an entry describing each task that has been published by a customer. The subscription store contains an entry for subscriptions of providers to published tasks. The subscription information can be used to notify providers when tasks are published that match the criterion of their subscription (e.g., using a publisher/subscriber model). The provider offer store contains an entry for each offer of a provider to perform a published task. The assigned task store contains a mapping of published tasks to the provider who the customer and the provider agree is to perform the task of the customer. The history store contains information describing the performance and other information about each transaction in which a provider performs a task for a customer. The task brokerage system may also include a workflow component that allows a customer to specify a sequence of tasks to be performed on the task and coordinates the performing of the tasks of the workflow. The task brokerage system also includes a recommendation system 160 with a recommend price component 161, a recommend provider component 162, a recommend task component 163, a document characteristic store 164, a recommendation criteria store 165, and a monitor store 166. The document characteristic store 164 contains characteristics of documents for which tasks have been published, and may store the document itself. The monitor store 166 contains information collected by the monitor module as a user modifies a document. The information of the monitor store may also be considered characteristics of the document. The recommendation criteria store contains entries that define the recommendation criteria that are used to recommend tasks to customers.

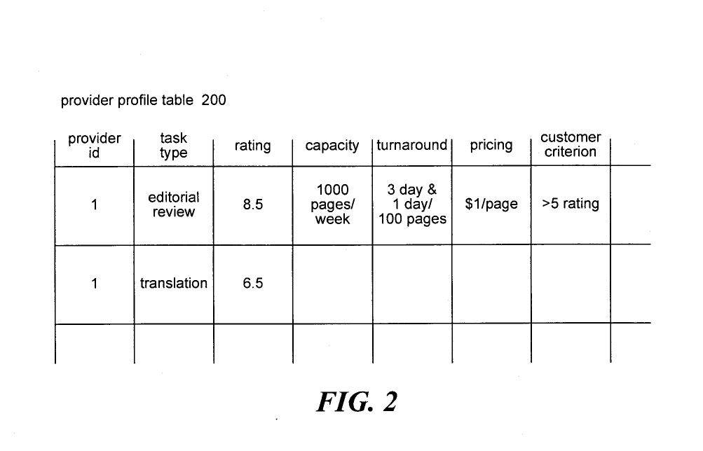

FIG. 2 illustrates a provider profile table used by the recommendation system in some embodiments. The provider profile table 200 may include an entry for each type of task that a provider provides. Each entry may include a provider identification field, a task type field, a rating field, a capacity field, a turnaround field, a pricing field, a customer criterion field, and so on. The rating field may specify the rating of the provider in performing the type of task. The customer criterion field may indicate a minimum rating of a customer for whom the provider is willing to perform tasks. The brokerage system may track provider ratings of customers. For example, a customer who regularly complains about the quality of work performed by providers may be given a low rating by those providers. The entries may contain many other fields relating to a provider such as years of experience with the task brokerage system, names of references, resume, and so on.

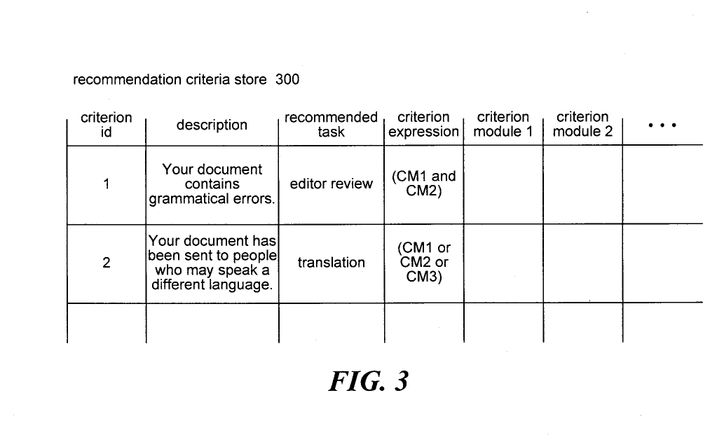

FIG. 3 illustrates a recommendation criteria store of the recommendation system in some embodiments. The recommendation criteria store 300 includes an entry for each recommendation criterion. Each entry may contain a criterion identifier field, a description field, a recommended task field, a criterion expression field, and various criteria module fields. The description field may contain text that is displayed to the participant for whom the recommendation is being made. The recommended task field identifies the type of task that will be recommended when the condition is satisfied. Each criterion module field may contain a reference to a function or module that is invoked to evaluate part of the condition and may return a Boolean value or a value in a range. The criterion expression field defines the condition of the recommendation criterion. The criterion expression field defines the Boolean logic to be applied to the results of the criterion module to determine whether the recommendation criterion is satisfied. The criterion modules may perform any type of processing on the data of the recommendation system and the task brokerage system including analysis of the document, document characteristics, and so on. Each criterion module may also return a textual description suitable for display to the participant when the condition of the recommendation criteria is satisfied.

The computing device on which the recommendation system is implemented may include a central processing unit, memory, input devices (e.g., keyboard and pointing devices), output devices (e.g., display devices), and storage devices (e.g., disk drives). The memory and storage devices are computer-readable media that may be encoded with computer-executable instructions that implement the recommendation system, which means a computer-readable medium that contains the instructions. In addition, the instructions, data structures, and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the recommendation system may be implemented in and used with various operating environments that include personal computers, server computers, hand-held or laptop devices, multiprocessor systems, microprocessor-based systems, programmable consumer electronics, digital cameras, network PCs, minicomputers, mainframe computers, computing environments that include any of the above systems or devices, and so on.

The recommendation system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments. The data structures illustrated include logical representations of data. The actual organization of the data structures may include hash tables, indexes, trees, and so on.

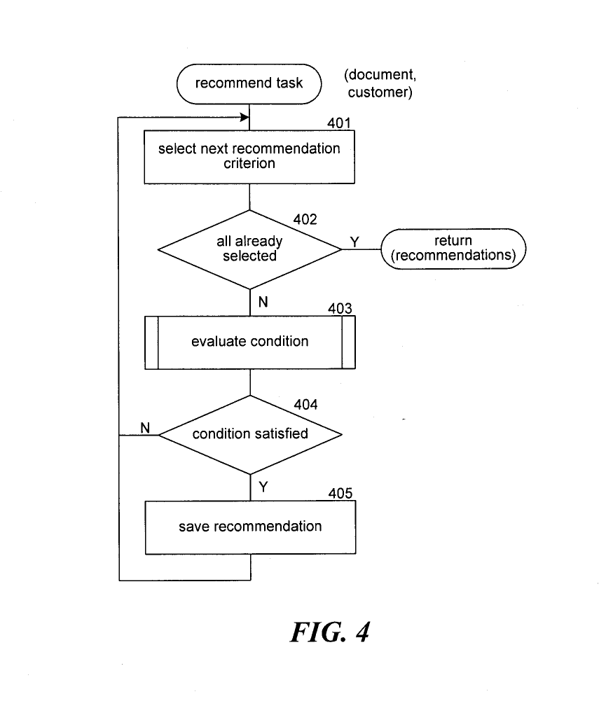

FIG. 4 is a flow diagram that illustrates the processing of the recommend task component of the recommendation system in some embodiments. The component may be invoked upon the occurrence of certain events to determine what if any tasks should be recommended to a participant. The component may be passed a document and characteristics associated with the document. In blocks 401-405, the component loops selecting each recommendation criterion and determining whether its condition is satisfied. In block 401, the component selects the next recommendation criterion from the recommendation criteria store. In decision block 402, if all the recommendation criteria have already been selected, then the component returns the recommendations that include tasks and possibly comments derived from the description of the recommendation criteria and the criterion modules, else the component continues at block 403. In block 403, the component evaluates the condition of the selected recommendation criterion. In decision block 404, if the condition of the selected recommendation criterion is satisfied, then the component continues at block 405, else the component loops to block 401 to select the next recommendation criterion. In block 405, the component saves an indication of the recommendation, which may include an indication of the task, the description associated with the recommendation criterion, the descriptions returned by the criterion modules, and so on. The component then loops to block 401 to select the next recommendation criterion. If multiple tasks are recommended, the task brokerage system may generate a workflow for the tasks.

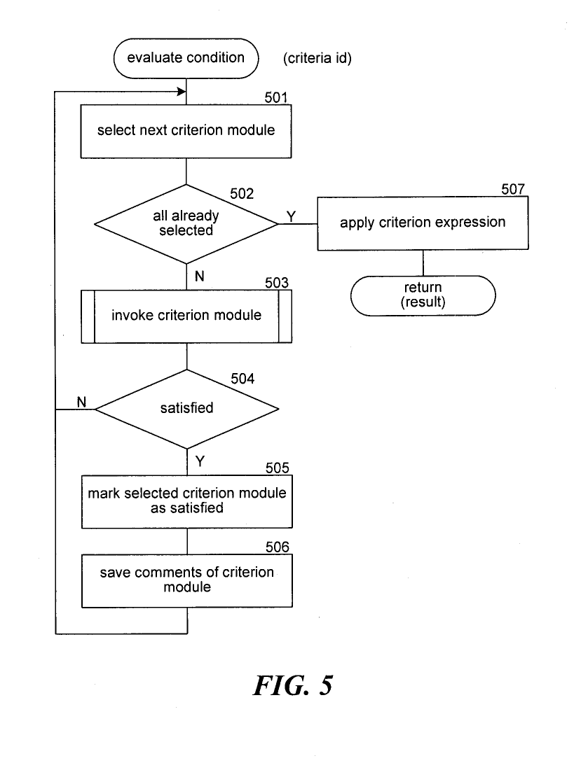

FIG. 5 is a flow diagram that illustrates the processing of the evaluate condition component of the recommendation system in some embodiments. The component is passed a recommendation criterion and returns an indication of whether the identified recommendation criterion is satisfied. In block 501-506, the component loops invoking the criterion modules of the recommendation criterion. In block 501, the component selects the next criterion module of the recommendation criterion. In decision block 502, if all the criterion modules have already been selected, then the component continues at block 507, else the component continues at block 503. In block 503, the component invokes the selected criterion module. In decision block 504, if the invoked criterion module returns an indication that it is satisfied (e.g., a Boolean value of true), then the component continues at block 505, else the component loops to block 501 to select the next criterion module. In block 505, the component marks the selected criterion module as being satisfied. In block 506, the component saves comments provided by the selected criterion module and then loops to block 501 to select the next criterion module. In block 507, the component applies the criterion expression to the Boolean values returned by the criterion modules and then returns the result of that expression indicating whether the condition of the recommendation criterion has been satisfied and any comments of the criterion modules.

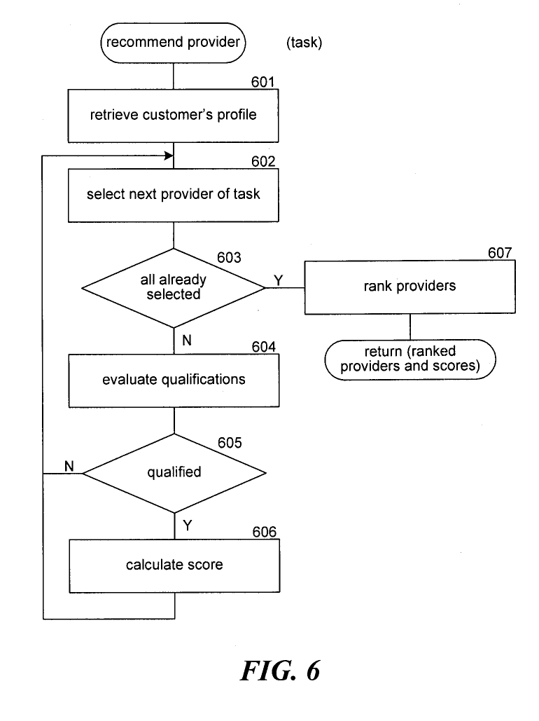

FIG. 6 is a flow diagram that illustrates the processing of the recommend provider component of the recommendation system in some embodiments. The component is passed a task provided by a customer and returns a ranking of providers who are qualified to perform the task. In block 601, the component retrieves the customer profile. In blocks 602-606, the component loops selecting each provider, evaluating their qualifications, and calculating provider scores. In block 602, the component selects the next provider of the type of task. In decision block 603, if all the providers have already been selected, then the component continues at block 607, else the component continues at block 604. In block 604, the component evaluates the qualifications of the selected provider. A provider may be considered to be qualified if the provider meets the minimum qualification to perform the task (e.g., capacity and rating). In decision block 605, if the selected provider is qualified, then the component continues at block 606, else the component loops to block 602 to select the next provider. In block 606, the component calculates the score for the qualified provider and then loops to block 602 to select the next provider. In block 607, the component ranks the providers based on their scores and returns a ranking of the providers and optionally their scores. In some embodiments, a task may specify an automatic assignment criterion. If a qualified provider satisfies the automatic assignment criterion, then the task brokerage system may automatically assign the task to that qualified provider. The providers may elect to opt out of automatic assignments. The task brokerage system may factor in capacity and price when making automatic assignments.

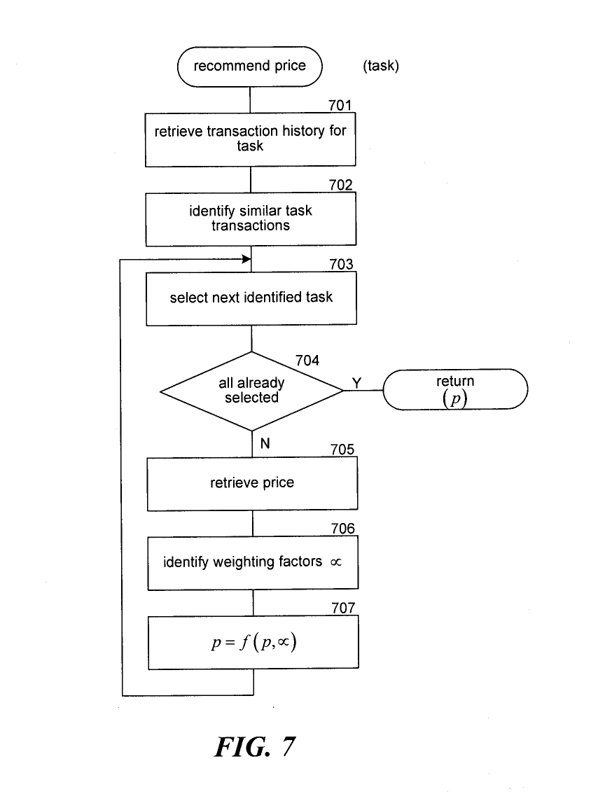

FIG. 7 is a flow diagram that illustrates the processing of the recommend price component of the recommendation system in some embodiments. The component is passed a target task and returns a recommended price for performing the target task. In block 701, the component retrieves the transaction history for tasks of the same type as a target task. In block 702, the component identifies transactions with similar tasks using a clustering or some other similarity measurement technique. In blocks 703-707, the component loops aggregating the price of each identified task into a recommended price for the target task. In block 703, the component selects the next identified task. In decision block 704, if all the identified tasks have already been selected, then the component returns the recommended price, else the component continues at block 705. In block 705, the component retrieves the price of the identified task. In block 706, the component identifies various weighting factors for the characteristics or features of the tasks. For example, the weight given to the price of the identified task may be based on how long ago the task was performed, how similar the number of pages is, how close the rating of the task is to the desired rating of the provider, the satisfaction of the customer of the identified tasks, and so on. In block 707, the component combines the price calculated so far with the weighting factors to generate a new price for the task. The component then loops to block 703 to select the next identified tasks.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. The participants may have separate ratings or metrics for different characteristics. For example, a provider may have a metric for their skill level, a metric for their pricing, a metric for their timeliness, a metric for their reputation, on so on. These different metric can be combined (i.e., weighted or unweighted) to give an overall metric for the participant. The task brokerage system may also test providers to evaluate their overall skills at performing a task. For example, providers may agree to participate in a random testing program in which the task brokerage system generates test tasks and assigns a test task to a provider. The provider performs the task without the knowledge that it is a test task. The brokerage system can then evaluate each provider's performance on the test task and use that evaluation to provide a rating for the provider. In exchange for participating in the random testing program, the providers may agree to waive their fees for performing any tasks that turn out to be test tasks. Accordingly, the invention is not limited except as by the appended claims.

We claim:

1. A method in a computing device for recommending a task to be performed on an electronic document in a task brokerage system that supports providers performing tasks for customers, the method comprising:
providing recommendation criteria, each recommendation criterion specifying a condition and a task, the condition specifying characteristics of a document for which the condition is satisfied;
providing characteristics of a document of a customer;
for each of a plurality of recommendation criteria,
determining whether the condition of the recommendation criterion is satisfied by the characteristics of the document; and
when it is determined that the condition of the recommendation criterion is satisfied, recommending to the customer that the task of the recommendation criterion be performed on the document; and
coordinating with a provider to have the provider perform the recommended task on the document.

2. The method of claim 1 including providing provider profiles describing attributes of providers and when a task is recommended to a customer, recommending a provider to perform the recommended task based on analysis of the provider profiles.

3. The method of claim 1 wherein the characteristics of the document include a history of changes made to the document.

4. The method of claim 1 wherein the document characteristics are derived from analysis of the document.

5. The method of claim 1 including recommending a price for performance of the recommended task.

6. The method of claim 1 wherein a recommendation criterion is defined by a broker of the task brokerage system.

7. The method of claim 1 wherein a recommendation criterion is defined by a participant using the task brokerage system.

8. The method of claim 1 wherein when multiple tasks are recommended, generating a workflow to track the performing of the tasks.

9. A method in a task brokerage system executing on a computing device for recommending a price for a task to be performed by a provider on an electronic document of a customer, the task brokerage system supporting providers performing tasks for customers, the method comprising:
monitoring transactions in which providers perform tasks on documents of customers;
for each monitored transaction, generating a transaction history entry with information describing the transaction, the transaction history including type of task, identification of the provider and the customer, and price that the customer paid to the provider for performing the task;
receiving a description of a target task to be performed on a document;
analyzing the transaction history to identify transactions with tasks that are similar to the target task;
calculating a price for the target task based on the prices of the identified transactions; and
storing an indication that the calculated price is the recommended price.

10. The method of claim 9 wherein the calculating includes weighting the price of an identified transaction based on the similarity of the task of the identified transaction to the target task.

11. The method of claim 9 wherein the calculating includes weighting the price of an identified transaction based on a comparison of designated characteristics of the task of the identified transaction and the target task.

12. The method of claim 9 wherein the recommended price includes a price range that is provided to a provider to assist the provider in pricing the performance of a task.

13. The method of claim 9 wherein the recommended price is provided to a customer to assist the customer in pricing the task.

14. The method of claim 9 wherein a target task specifies a minimum value for an attribute such that when a task of a transaction does not meet that minimum value, the task of the transaction is considered to be not similar.

15. The method of claim 14 wherein the attribute is a rating of a provider.

16. The method of claim 9 wherein the calculating of the price factors in time requirements of the target task.

17. A method in a task brokerage system executing on a computing device for recommending a provider for performing a task on an electronic document of a customer, the task brokerage system supporting providers performing tasks for customers, the method comprising:
providing provider profiles indicating the type of tasks performed by the providers;
monitoring the performance of providers in performing tasks on electronic documents for customers and storing performance history information for the providers;
collecting from customers rating information relating to providers who performed tasks for the customers;
receiving a description of a target task to be performed on a document that includes a type of task;
analyzing the provider profiles, performance history, and rating information to identify providers who are qualified to perform the target task;
generating a score for each qualified provider indicating expected overall satisfaction of the customer with the performance of the task by the provider; and
ranking the qualified providers based on the generated scores.

18. The method of claim 17 including presenting to a customer from whom the description of the target task was received a ranked listing of the qualified providers.

19. The method of claim 17 including evaluating an automatic assignment criterion of the customer and when a qualified provider satisfies the automatic assignment criterion, automatically assigning the target task to that qualified provider.

20. The method of claim 17 including notifying a qualified provider of its qualification so that it can offer to perform the target task.
